(19) United States
(12) Patent Application Publication
(10) Pub. No.: US 2026/0255172 A1
(43) Pub. Date: Aug. 27, 2026

(54) SYSTEMS AND METHODS FOR LOCKING AND UNLOCKING SUBSCRIBER IDENTIFICATION MODULES

(71) Applicant: Verizon Patent and Licensing Inc., Basking Ridge, NJ (US)

(72) Inventors: Taussif KHAN, Martinsville, NJ (US); Alexandre DE MELO, Basking Ridge, NJ (US); Lee WHRITENOUR, Arlington, VA (US); Axel HALLO DE WOLF, Whippany, NJ (US)

(73) Assignee: Verizon Patent and Licensing Inc., Basking Ridge, NJ (US)

(21) Appl. No.: 18/989,991

(22) Filed: Dec. 20, 2024

(51) Int. Cl. H04W 12/30; H04W 12/71

(52) U.S. Cl. CPC H04W 12/35; H04W 12/71

(57) ABSTRACT

In some implementations, a subscriber identification module (SIM) associated with a user equipment (UE) includes one or more components configured to: initialize the SIM during an on power state of the UE, wherein the SIM is locked to the UE based on an international mobile equipment identity (IMEI) lock being enabled; and determine whether to disable the IMEI lock, maintain the IMEI lock, or reenable the IMEI lock based on one or more conditions being satisfied, wherein the SIM is not locked to the UE when the IMEI lock is disabled.

### BACKGROUND

Communication systems are widely deployed to provide various telecommunication services such as telephony, video, data, messaging, and broadcasts. A network may include one or more network devices that support communication for wireless communication devices.

### BRIEF DESCRIPTION OF THE DRAWINGS

FIG. 1 is a diagram of an example associated with locking and unlocking subscriber identification modules (SIMs).

FIG. 2 is a diagram of an example associated with locking and unlocking SIMs.

FIG. 3 is a diagram of an example associated with locking and unlocking SIMs.

FIG. 4 is a diagram of an example associated with locking and unlocking SIMs.

FIG. 5 is a diagram of an example environment in which systems and/or methods described herein may be implemented.

FIG. 6 is a diagram of example components of one or more devices of FIG. 5.

FIG. 7 is a flowchart of an example process associated with locking and unlocking SIMs.

### DETAILED DESCRIPTION OF EXAMPLE EMBODIMENTS

The following detailed description of example implementations refers to the accompanying drawings. The same reference numbers in different drawings may identify the same or similar elements.

An entity, which may include an individual, may initiate an unwanted communication to a recipient. The unwanted communication may include an unwanted voice call and/or an unwanted text message. The unwanted communication may be related to spam, which may involve a legitimate entity attempting to sell a product or service to the recipient. The unwanted communication may be related to a scam, which may involve an impersonation of a legitimate entity in order to defraud the recipient. The entity that initiates the unwanted communication may be a spammer, a scammer, and/or a fraudster.

The unwanted communication may be made using a prepaid subscriber identification module (SIM) card, which may allow the entity to remain anonymous. The prepaid SIM card may not require a same level of identification or personal information as a traditional account, so the entity may use the prepaid SIM card to hide a personal identity. The prepaid SIM card may make it difficult to trace a source of the unwanted communication. The prepaid SIM card may be used for the unwanted communication due to anonymity, disposability, and/or low cost. The prepaid SIM card may be purchased without requiring personal identification, making it easier for the entity to remain anonymous. The prepaid SIM card may be easily discarded or switched out after making a series of unwanted communications, which may allow the entity to avoid detection and blocking. The prepaid SIM card may be inexpensive, so the entity may make a large volume of unwanted communication without significant cost. The entity may purchase prepaid SIM cards in bulk, obtain service without providing personal details (e.g., verifiable details), and use those lines to make the unwanted communications.

The unwanted communication may be made by the entity using a SIM box. The SIM box may be a device that holds a plurality of prepaid SIM cards and/or a plurality of modems. For example, the SIM box may include 512 prepaid SIM cards and 16 modems. The SIM box may be used to route the unwanted communication, which may appear to be coming from a local or domestic phone number. The SIM box may allow for numerous unwanted communications to be launched in a simultaneous manner.

Unwanted communications using the prepaid SIM card and/or the SIM box may waste system resources. For example, the unwanted communications may waste compute resources, network resources, and/or storage resources. The unwanted communications may create an undesirable strain on a wireless communication network, which may affect a performance of legitimate communications (e.g., legitimate voice calls and/or legitimate text messages), thereby degrading an overall system performance.

In some implementations, a user equipment (UE), which may include a SIM box, may be powered on with a SIM. The UE may be associated with an international mobile equipment identity (IMEI). By default, the SIM may be locked to the UE based on an IMEI lock being enabled. In other words, with the IMEI lock, the SIM may be locked to the IMEI associated with the UE, such that if the SIM were to be moved to another UE, the SIM would not be operable in the other UE. The IMEI lock may be disabled, the IMEI lock may be maintained, and/or the IMEI lock may be reenabled when certain conditions are satisfied. The certain conditions may be related to a bearer independent protocol (BIP) check. The BIP check may correspond to a communication protocol between the SIM and a SIM over-the-air (OTA) platform. The certain conditions may be related to an IMEI application counter, which may be incremented each time the SIM is moved to another UE. The certain conditions may be related to profile information, which may be retrieved from the UE when the UE is powered on. The IMEI lock may be enabled and/or disabled accordingly depending on whether the certain conditions are satisfied, which may allow for false positives to be reversed and for legitimate users to not be impacted.

In some implementations, by enabling the IMEI lock to be enabled and/or disabled when the certain conditions are satisfied, the SIM may be prevented from being used in other UEs, which may help to reduce unwanted communications (e.g., unwanted spam/scam voice calls and/or text messages). Enabling the IMEI lock when the certain conditions are satisfied may cause the SIM to not be useable in the other UEs, which may increase a likelihood that the SIM will be discarded and not used to make the unwanted communications. As a result, a reduction in unwanted communications may reduce system resources. The reduction in unwanted communications may reduce a strain on a wireless communication network, which may improve a performance of legitimate communications, thereby improving an overall system performance.

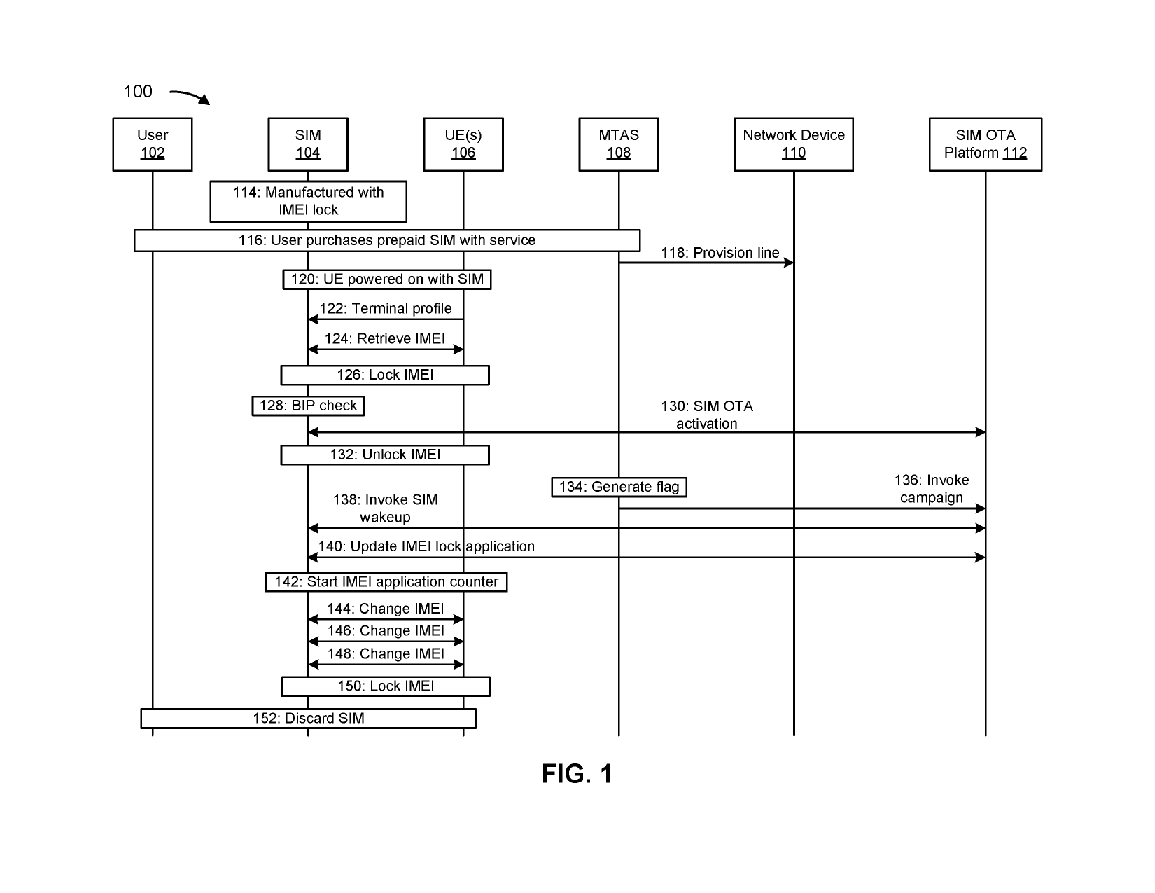

FIG. 1 is a diagram of an example 100 associated with locking and unlocking SIMs. As shown in FIG. 1, example 100 includes a SIM 104, a UE 106 (or multiple UEs 106), a mobile telephony application server (MTAS) 108, a network device 110, and a SIM OTA platform 112. The SIM 104 may be associated with the UE 106. The SIM 104 and/or the UE 106 may be associated with a user 102. The SIM 104 may or may not be associated with a SIM box. The SIM 104 may be a prepaid SIM.

As shown by reference number 114, when a SIM lock is based on a network based trigger (e.g., when the SIM lock is triggered by a pattern based network detection), the SIM 104 may be manufactured with an IMEI lock. The SIM 104 may be locked to a particular UE 106 when the IMEI lock is enabled. The SIM 104 may be locked to a particular IMEI that is associated with the particular UE 106 when the IMEI lock is enabled. In this case, the SIM 104 may only be operable with the particular UE 106, and the SIM 104 may not be operable when inserted into another UE 106. When the SIM 104 is inserted into the other UE 106, the UE 106 may be unable to attach to the network device 110. As shown by reference number 116, the SIM 104 may be purchased by the user 102. The SIM 104 may support a prepaid mobile service (e.g., voice calls and/or text messaging).

As shown by reference number 118, the MTAS 108 may transmit signaling to the network device 110 in order to provision a line for the SIM 104. As shown by reference number 120, the UE 106 may be powered on with the SIM 104. In other words, the SIM 104 may be associated with the UE 106 and then the UE 106 may be powered on. As shown by reference number 122, the UE 106 may provide profile information (e.g., terminal profile) to the SIM 104. As shown by reference number 124, the SIM 104 may retrieve an IMEI from the UE 106. For example, the SIM 104 may send a request for the IMEI, and the UE 106 may respond with the IMEI. The SIM 104 may store the IMEI associated with the UE 106. As shown by reference number 126, the IMEI lock may be enabled (e.g., the IMEI may be locked), which may prevent the SIM 104 from being used on another UE 106.

As shown by reference number 128, the SIM 104 may perform a BIP check. The BIP check may correspond to a communication protocol between the SIM 104 and the SIM OTA platform 112. The BIP check may be used to determine whether the SIM 104 is able to communicate with the SIM OTA platform 112. When the BIP check indicates that the SIM 104 is allowed to communicate with the SIM OTA platform 112, the SIM 104 may be assumed to be associated with a good UE 106 (e.g., a UE 106 used to make legitimate communications). When the BIP check indicates that the SIM 104 is not allowed to communicate with the SIM OTA platform 112, the SIM 104 may be assumed to be associated with a bad UE 106 (e.g., a UE 106 used to make unwanted communications). As shown by reference number 130, the SIM 104 may perform a SIM OTA activation with the SIM OTA platform 112, which may be based on the BIP check. In this case, the SIM 104 may be able to communicate with the SIM OTA platform 112, which may be indicated by the BIP check. As shown by reference number 132, the IMEI lock may be disabled (e.g., the IMEI may be unlocked), which may allow the SIM 104 to be used on another UE 106. The IMEI lock may be disabled based on the BIP check and/or the SIM OTA activation. When the IMEI lock is disabled, the SIM 104 may be able to be used on another UE 106 (or on multiple UEs 106).

As shown by reference number 134, the MTAS 108 may generate a flag, which may be in response to the SIM 104 being used on a certain number of other UEs 106 within a certain time period. For example, the SIM 104 may be used on 5 other UEs 106 in one day, which may cause the flag to be generated. The MTAS 108 may generate the flag based on the pattern based network detection. The SIM 104 may report, to the MTAS 108 and/or the network device 110, when the SIM 104 is being used on another UE 106, which may allow the MTAS 108 to detect the certain number of other UEs 106 within the certain time period and then generate the flag. The flag may indicate that the SIM 104 is potentially being used for unwanted behavior (e.g., making unwanted communications). As shown by reference number 136, the MTAS 108 may transmit, to the SIM OTA platform 112, a campaign invoke signaling, and as shown by reference number 138, the SIM OTA platform 112 may transmit, to the SIM 104 and based on the campaign invoke signaling, a SIM wakeup invoked signaling. As shown by reference number 140, the SIM 104 and the SIM OTA platform 112 may exchange signaling to update an IMEI lock application, which may be based on the SIM wakeup invoked signaling.

As shown by reference number 142, the SIM 104 may start an IMEI application counter, which may be based on the signaling to update the IMEI lock application. As shown by reference number 144, the SIM 104 may be used on another UE 106, which may increment the IMEI application counter. As shown by reference number 146, the SIM 104 may be used on another UE 106, which may increment the IMEI application counter. As shown by reference number 148, the SIM 104 may be used on another UE 106, which may increment the IMEI application counter. In this example, the IMEI application counter may reach a threshold value, which may be based on the IMEI application counter being incremented a certain number of times within a defined time period. The threshold value may be a configurable value. As shown by reference number 150, the IMEI lock may be enabled (e.g., the IMEI may be locked), which may prevent the SIM 104 from being used on another UE 106. As shown by reference number 152, the SIM 104 may be discarded, which may be due to the SIM 104 no longer being useable for performing fraudulent activity. In this example, the SIM 104 may no longer be used to make unwanted communications. Since the SIM 104 may be the prepaid SIM, discarding the SIM 104 with presumably remaining funds may be undesirable from the perspective of the fraudulent user. Alternatively, when the SIM 104 is being used for legitimate communications, the UE 106 may contact customer care, and when certain conditions are satisfied (e.g., the user 102 is able to provide information to show the user 102 is not fraudulent), the IMEI lock may be disabled (e.g., the IMEI may be unlocked) with respect to a certain UE 106.

In some implementations, the UE 106 may be associated with a SIM box, where the SIM box may include a plurality of modems. The SIM 104 may be used by a first modem, of the plurality of modems, which may increment the IMEI application counter. The SIM 104 may then be used by a second modem, of the plurality of modems, which may further increment the IMEI application counter. The SIM 104 may then be used by a third modem, of the plurality of modems, which may further increment the IMEI application counter. In this example, the IMEI application counter may reach a threshold value, which may be based on the IMEI application counter being incremented a certain number of times within a defined time period. After the IMEI application counter reaches the threshold value, the IMEI lock may be enabled (e.g., the IMEI may be locked), which may prevent the SIM 104 from being used on another modem of the plurality of modems. If the user 102 attempts to use the SIM 104 on another modem, the SIM 104 may be non-functional on that modem.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

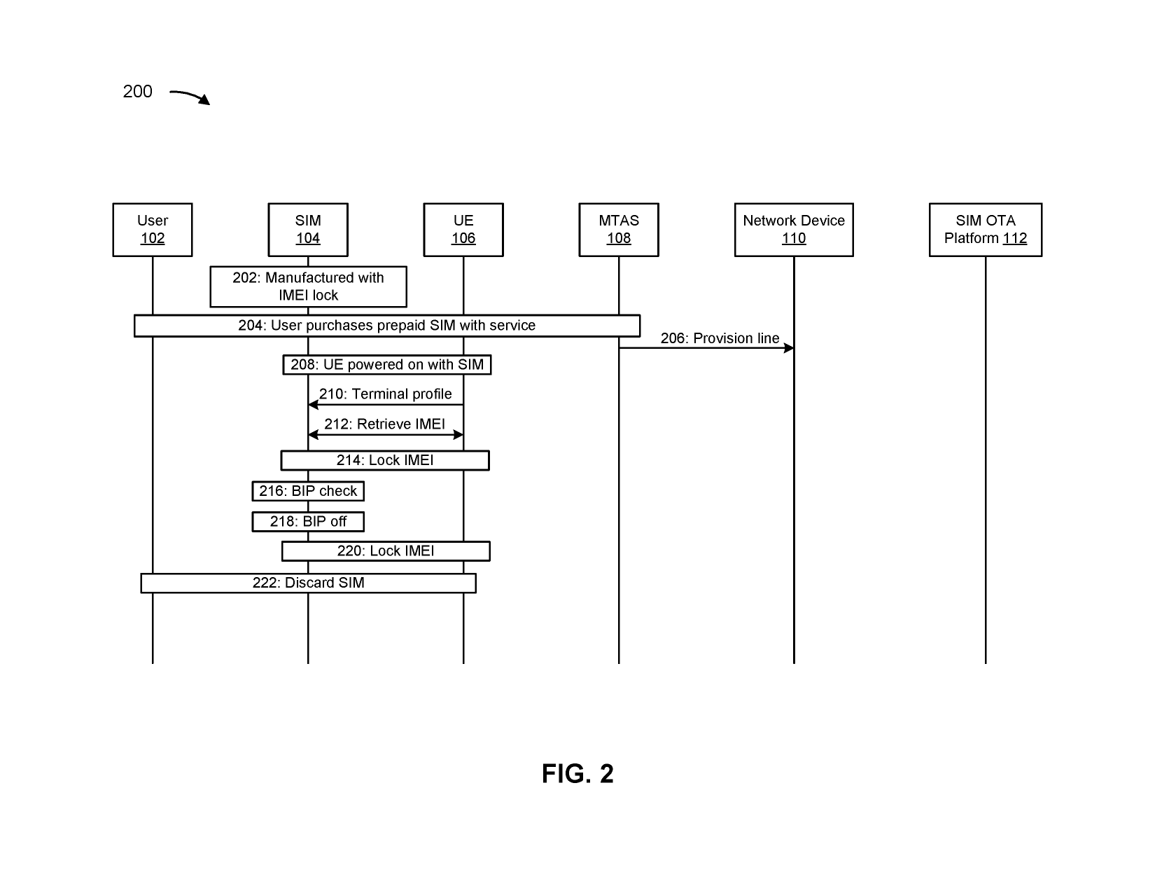

FIG. 2 is a diagram of an example 200 associated with locking and unlocking SIMs. As shown in FIG. 2, example 200 includes a SIM 104, a UE 106, an MTAS 108, a network device 110, and a SIM OTA platform 112. The SIM 104 may be associated with the UE 106. The SIM 104 and/or the UE 106 may be associated with a user 102. The SIM 104 may or may not be associated with a SIM box. The SIM 104 may be a prepaid SIM.

As shown by reference number 202, when a fraudster is using a bad UE 106, the SIM 104 may be manufactured with an IMEI lock. The SIM 104 may be locked to a particular UE 106 when the IMEI lock is enabled. The SIM 104 may be locked to a particular IMEI that is associated with the particular UE 106 when the IMEI lock is enabled. In this case, the SIM 104 may only be operable with the particular UE 106, and the SIM 104 may not be operable when inserted into another UE 106. As shown by reference number 204, the SIM 104 may be purchased by the user 102. The SIM 104 may support a prepaid mobile service (e.g., voice calls and/or text messaging).

As shown by reference number 206, the MTAS 108 may transmit signaling to the network device 110 in order to provision a line for the SIM 104. As shown by reference number 208, the UE 106 may be powered on with the SIM 104. In other words, the SIM 104 may be associated with the UE 106 and then the UE 106 may be powered on. As shown by reference number 210, the UE 106 may provide profile information (e.g., terminal profile) to the SIM 104. As shown by reference number 212, the SIM 104 may retrieve an IMEI from the UE 106. For example, the SIM 104 may send a request for the IMEI, and the UE 106 may respond with the IMEI. The SIM 104 may store the IMEI associated with the UE 106. As shown by reference number 214, the IMEI lock may be enabled (e.g., the IMEI may be locked), which may prevent the SIM 104 from being used on another UE 106.

As shown by reference number 216, the SIM 104 may perform a BIP check, which may be used to determine whether the SIM 104 is able to communicate with the SIM OTA platform 112. When the BIP check indicates that the SIM 104 is allowed to communicate with the SIM OTA platform 112, the SIM 104 may be assumed to be associated with a good UE 106 (e.g., a UE 106 used to make legitimate communications). When the BIP check indicates that the SIM 104 is not allowed to communicate with the SIM OTA platform 112, the SIM 104 may be assumed to be associated with a bad UE 106 (e.g., a UE 106 used to make unwanted communications). As shown by reference number 218, the SIM 104 may determine that the SIM 104 is not able to communicate with the SIM OTA platform 112 (e.g., BIP off), which may be based on the BIP check. As shown by reference number 220, the IMEI lock may be enabled (e.g., the IMEI may be locked), which may prevent the SIM 104 from being used on another UE 106. The IMEI lock may be enabled based on the SIM 104 not being able to communicate with the SIM OTA platform 112. As shown by reference number 222, the SIM 104 may be discarded, which may be due to the SIM 104 no longer being useable for performing fraudulent activity.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

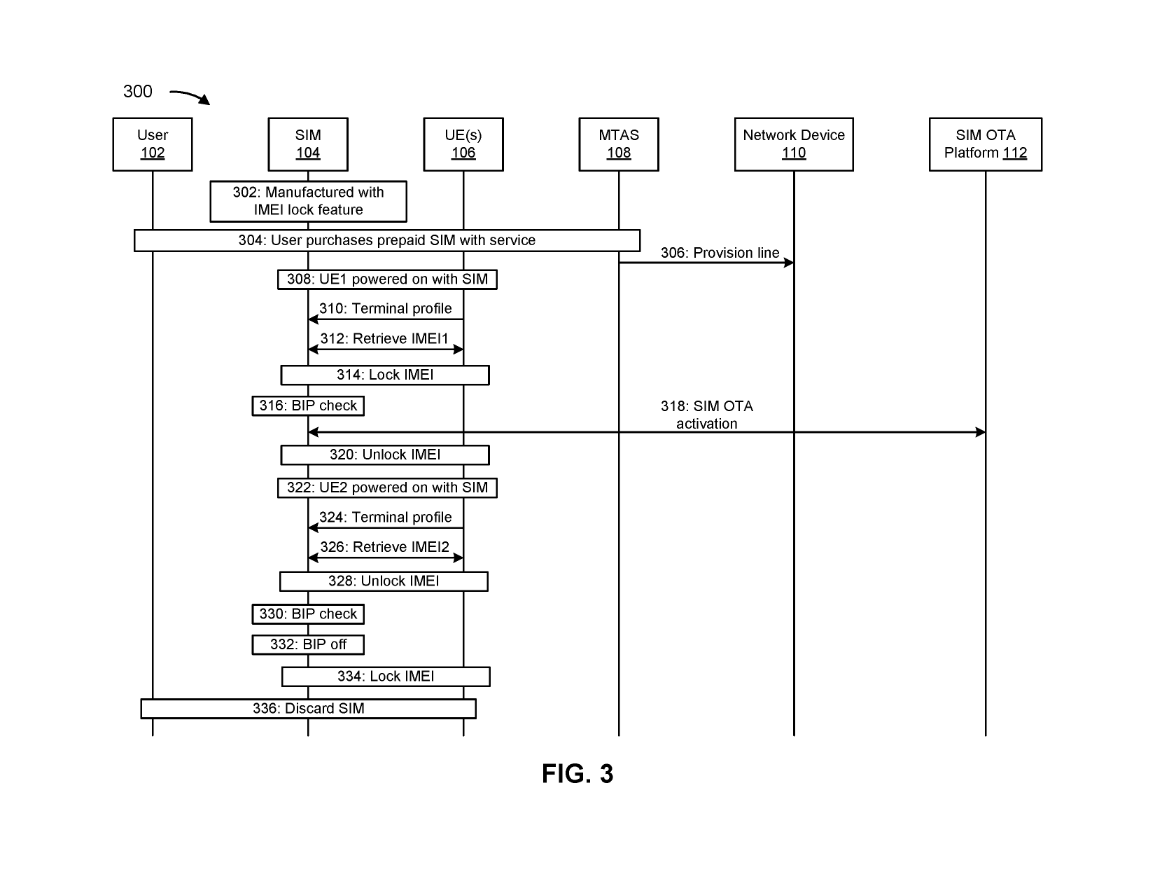

FIG. 3 is a diagram of an example 300 associated with locking and unlocking SIMs. As shown in FIG. 3, example 300 includes a SIM 104, a UE 106 (or multiple UEs 106), an MTAS 108, a network device 110, and a SIM OTA platform 112. The SIM 104 may be associated with the UE 106. The SIM 104 and/or the UE 106 may be associated with a user 102. The SIM 104 may or may not be associated with a SIM box. The SIM 104 may be a prepaid SIM.

As shown by reference number 302, when a fraudster is using an approved UE 106 to initiate an initial activation and then moving the SIM 104 to a bad UE 106, the SIM 104 may be manufactured with an IMEI lock. The SIM 104 may be locked to a particular UE 106 when the IMEI lock is enabled. The SIM 104 may be locked to a particular IMEI that is associated with the particular UE 106 when the IMEI lock is enabled. In this case, the SIM 104 may only be operable with the particular UE 106, and the SIM 104 may not be operable when inserted into another UE 106. As shown by reference number 304, the SIM 104 may be purchased by the user 102. The SIM 104 may support a prepaid mobile service (e.g., voice calls and/or text messaging).

As shown by reference number 306, the MTAS 108 may transmit signaling to the network device 110 in order to provision a line for the SIM 104. As shown by reference number 308, the UE 106 (UE1) may be powered on with the SIM 104. In other words, the SIM 104 may be associated with the UE 106 and then the UE 106 may be powered on. As shown by reference number 310, the UE 106 may provide profile information (e.g., terminal profile) to the SIM 104. As shown by reference number 312, the SIM 104 may retrieve an IMEI from the UE 106. For example, the SIM 104 may send a request for the IMEI, and the UE 106 may respond with the IMEI. The SIM 104 may store the IMEI associated with the UE 106. As shown by reference number 314, the IMEI lock may be enabled (e.g., the IMEI may be locked), which may prevent the SIM 104 from being used on another UE 106.

As shown by reference number 316, the SIM 104 may perform a BIP check, which may be used to determine whether the SIM 104 is able to communicate with the SIM OTA platform 112. When the BIP check indicates that the SIM 104 is allowed to communicate with the SIM OTA platform 112, the SIM 104 may be assumed to be associated with a good UE 106 (e.g., a UE 106 used to make legitimate communications). When the BIP check indicates that the SIM 104 is not allowed to communicate with the SIM OTA platform 112, the SIM 104 may be assumed to be associated with a bad UE 106 (e.g., a UE 106 used to make unwanted communications). As shown by reference number 318, the SIM 104 may perform a SIM OTA activation with the SIM OTA platform 112, which may be based on the BIP check. In this case, the SIM 104 may be able to communicate with the SIM OTA platform 112, which may be indicated by the BIP check. As shown by reference number 320, the IMEI lock may be disabled (e.g., the IMEI may be unlocked), which may allow the SIM 104 to be used on another UE 106. The IMEI lock may be disabled based on the BIP check and/or the SIM OTA activation. When the IMEI lock is disabled, the SIM 104 may be able to be used on another UE 106 (or on multiple UEs 106).

As shown by reference number 322, the UE 106 (UE2) may be powered on with the SIM 104. In other words, the SIM 104 may be associated with the UE 106 and then the UE 106 may be powered on. In this example, the user 102 may move the SIM 104 between UEs. As shown by reference number 324, the UE 106 may provide profile information (e.g., terminal profile) to the SIM 104. As shown by reference number 326, the SIM 104 may retrieve an IMEI from the UE 106. For example, the SIM 104 may send a request for the IMEI, and the UE 106 may respond with the IMEI. The SIM 104 may store the IMEI associated with the UE 106. As shown by reference number 328, the IMEI lock may be disabled (e.g., the IMEI may be unlocked), which may allow the SIM 104 to be used on another UE 106.

As shown by reference number 330, the SIM 104 may perform a BIP check, which may be used to determine whether the SIM 104 is able to communicate with the SIM OTA platform 112. When the BIP check indicates that the SIM 104 is allowed to communicate with the SIM OTA platform 112, the SIM 104 may be assumed to be associated with a good UE 106 (e.g., a UE 106 used to make legitimate communications). When the BIP check indicates that the SIM 104 is not allowed to communicate with the SIM OTA platform 112, the SIM 104 may be assumed to be associated with a bad UE 106 (e.g., a UE 106 used to make unwanted communications). As shown by reference number 332, the SIM 104 may determine that the SIM 104 is not able to communicate with the SIM OTA platform 112 (e.g., BIP off), which may be based on the BIP check. As shown by reference number 334, the IMEI lock may be enabled (e.g., the IMEI may be locked), which may prevent the SIM 104 from being used on another UE 106. The IMEI lock may be enabled based on the SIM 104 not being able to communicate with the SIM OTA platform 112. As shown by reference number 336, the SIM 104 may be discarded, which may be due to the SIM 104 no longer being useable for performing fraudulent activity.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

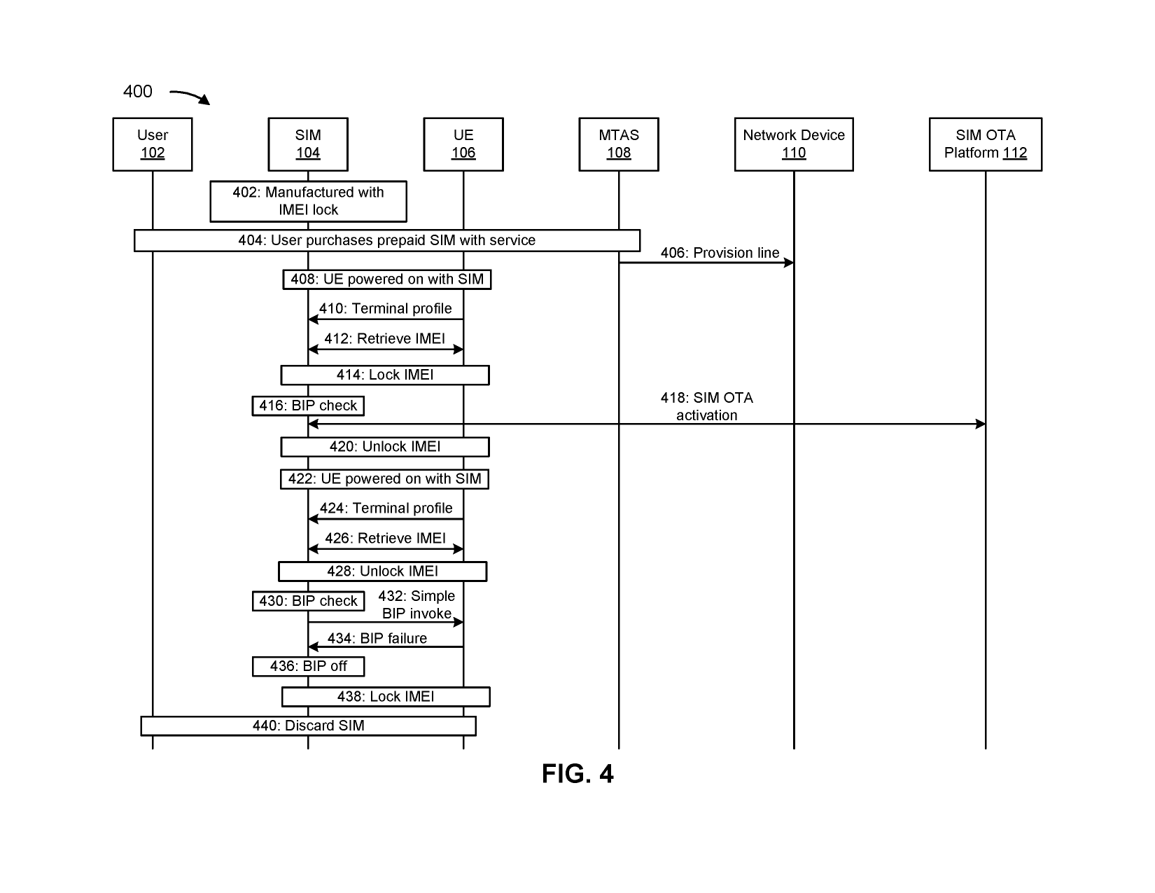

FIG. 4 is a diagram of an example 400 associated with locking and unlocking SIMs. As shown in FIG. 4, example 400 includes a SIM 104, a UE 106, an MTAS 108, a network device 110, and a SIM OTA platform 112. The SIM 104 may be associated with the UE 106. The SIM 104 and/or the UE 106 may be associated with a user 102. The SIM 104 may or may not be associated with a SIM box. The SIM 104 may be a prepaid SIM.

As shown by reference number 402, when a fraudster uses false information to fake out an application, the SIM 104 may be manufactured with an IMEI lock. The SIM 104 may be locked to a particular UE 106 when the IMEI lock is enabled. The SIM 104 may be locked to a particular IMEI that is associated with the particular UE 106 when the IMEI lock is enabled. In this case, the SIM 104 may only be operable with the particular UE 106, and the SIM 104 may not be operable when inserted into another UE 106. As shown by reference number 404, the SIM 104 may be purchased by the user 102. The SIM 104 may support a prepaid mobile service (e.g., voice calls and/or text messaging).

As shown by reference number 406, the MTAS 108 may transmit signaling to the network device 110 in order to provision a line for the SIM 104. As shown by reference number 408, the UE 106 may be powered on with the SIM 104. In other words, the SIM 104 may be associated with the UE 106 and then the UE 106 may be powered on. As shown by reference number 410, the UE 106 may provide profile information (e.g., terminal profile) to the SIM 104. As shown by reference number 412, the SIM 104 may retrieve an IMEI from the UE 106. For example, the SIM 104 may send a request for the IMEI, and the UE 106 may respond with the IMEI. The SIM 104 may store the IMEI associated with the UE 106. As shown by reference number 414, the IMEI lock may be enabled (e.g., the IMEI may be locked), which may prevent the SIM 104 from being used on another UE 106.

As shown by reference number 416, the SIM 104 may perform a BIP check, which may be used to determine whether the SIM 104 is able to communicate with the SIM OTA platform 112. When the BIP check indicates that the SIM 104 is allowed to communicate with the SIM OTA platform 112, the SIM 104 may be assumed to be associated with a good UE 106 (e.g., a UE 106 used to make legitimate communications). When the BIP check indicates that the SIM 104 is not allowed to communicate with the SIM OTA platform 112, the SIM 104 may be assumed to be associated with a bad UE 106 (e.g., a UE 106 used to make unwanted communications). As shown by reference number 418, the SIM 104 may perform a SIM OTA activation with the SIM OTA platform 112, which may be based on the BIP check. In this case, the SIM 104 may be able to communicate with the SIM OTA platform 112, which may be indicated by the BIP check. As shown by reference number 420, the IMEI lock may be disabled (e.g., the IMEI may be unlocked), which may allow the SIM 104 to be used on another UE 106. The IMEI lock may be disabled based on the BIP check and/or the SIM OTA activation. When the IMEI lock is disabled, the SIM 104 may be able to be used on another UE 106 (or on multiple UEs 106).

As shown by reference number 422, the UE 106 (e.g., another UE 106) may be powered on with the SIM 104. As shown by reference number 424, the UE 106 may provide profile information (e.g., terminal profile) to the SIM 104. As shown by reference number 426, the SIM 104 may retrieve an IMEI from the UE 106. For example, the SIM 104 may send a request for the IMEI, and the UE 106 may respond with the IMEI. The SIM 104 may store the IMEI associated with the UE 106. As shown by reference number 428, the IMEI lock may be disabled (e.g., the IMEI may be unlocked), which may allow the SIM 104 to be used on another UE 106. The IMEI lock may be disabled based on the fraudster using the false information to fake out the application. For example, the profile information may be modified to indicate that the UE 106 supports BIP, even when the UE 106 does not actually support BIP, which may cause the IMEI lock to be disabled.

As shown by reference number 430, the SIM 104 may perform a BIP check, which may be used to determine whether the SIM 104 is able to communicate with the SIM OTA platform 112. When the BIP check indicates that the SIM 104 is allowed to communicate with the SIM OTA platform 112, the SIM 104 may be assumed to be associated with a good UE 106 (e.g., a UE 106 used to make legitimate communications). When the BIP check indicates that the SIM 104 is not allowed to communicate with the SIM OTA platform 112, the SIM 104 may be assumed to be associated with a bad UE 106 (e.g., a UE 106 used to make unwanted communications).

As shown by reference number 432, the SIM 104 may send BIP invoke signaling to the UE 106, and as shown by reference number 434, the UE 106 may respond with signaling that indicates a BIP failure. The BIP failure may be based on the UE 106 not supporting BIP. As shown by reference number 436, the SIM 104 may determine that the SIM 104 is not able to communicate with the SIM OTA platform 112 (e.g., BIP off), which may be based on the BIP failure. As shown by reference number 438, the IMEI lock may be enabled (e.g., the IMEI may be locked), which may prevent the SIM 104 from being used on another UE 106. The IMEI lock may be enabled based on the SIM 104 not being able to communicate with the SIM OTA platform 112. As shown by reference number 440, the SIM 104 may be discarded, which may be due to the SIM 104 no longer being useable for performing fraudulent activity.

As indicated above, FIG. 4 is provided as an example. Other examples may differ from what is described with regard to FIG. 4. The number and arrangement of devices shown in FIG. 4 are provided as an example. In practice, there may be additional devices, fewer devices, different devices, or differently arranged devices than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) shown in FIG. 4 may perform one or more functions described as being performed by another set of devices shown in FIG. 4.

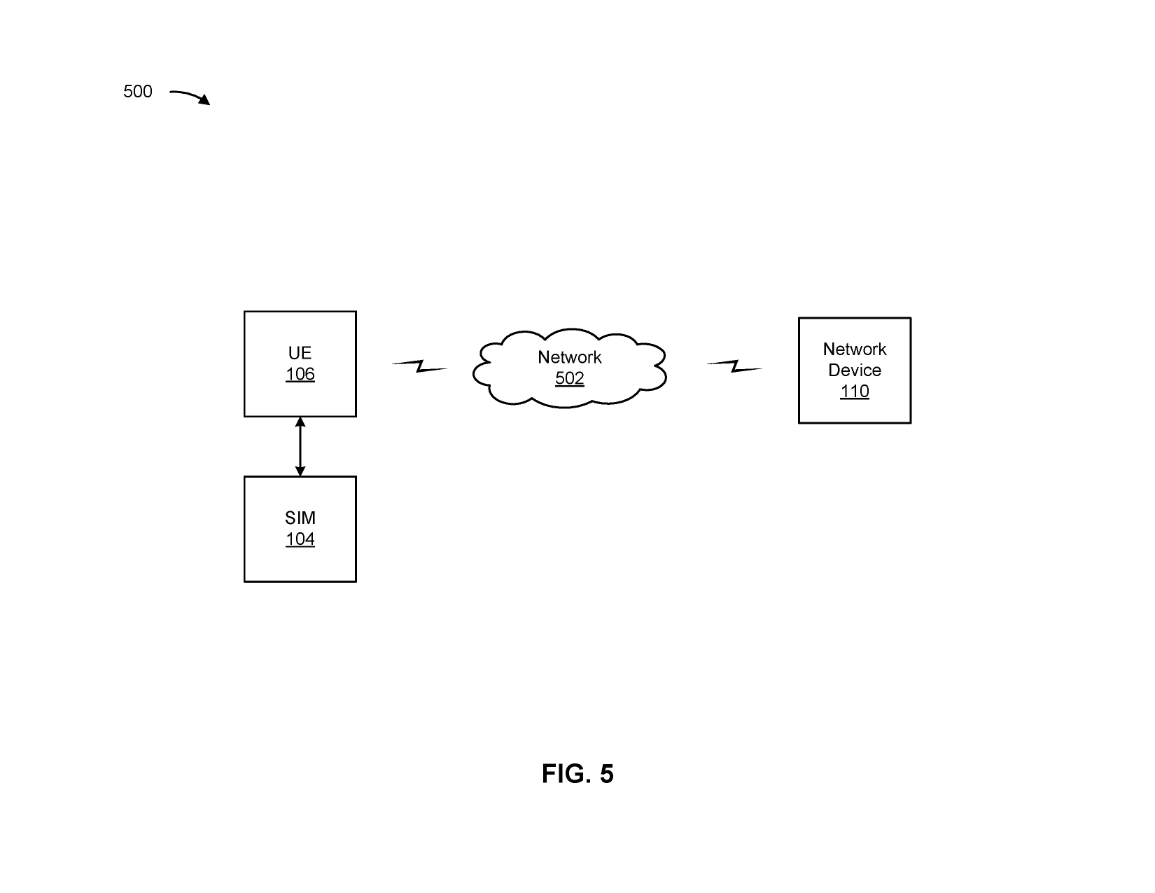

FIG. 5 is a diagram of an example environment 500 in which systems and/or methods described herein may be implemented. As shown in FIG. 5, environment 500 may include a UE 106 which may be associated with a SIM 104, a network device 110, and a network 502. Devices of environment 500 may interconnect via wired connections, wireless connections, or a combination of wired and wireless connections.

The UE 106 may include one or more devices capable of receiving, generating, storing, processing, and/or providing information associated with locking and unlocking SIMs, as described elsewhere herein. The UE 106 may include a communication device and/or a computing device. For example, the UE 106 may include a wireless communication device, a mobile phone, a laptop computer, a tablet computer, a desktop computer, a gaming console, a set-top box, a wearable communication device (e.g., a smart wristwatch, a pair of smart eyeglasses, a head mounted display, or a virtual reality headset), a smart television, an Internet of Things (IoT) device, or a similar type of device.

The network device 110 may include one or more devices capable of receiving, processing, storing, routing, and/or providing information associated with locking and unlocking SIMs, as described elsewhere herein. The network device 110 may be an aggregated network node, meaning that the aggregated network node is configured to utilize a radio protocol stack that is physically or logically integrated within a single radio access network (RAN) node (e.g., within a single device or unit). The network device 110 may be a disaggregated network node (sometimes referred to as a disaggregated base station), meaning that the network device 110 is configured to utilize a protocol stack that is physically or logically distributed among two or more nodes (such as one or more central units (CUs), one or more distributed units (DUs), or one or more radio units (RUs)). The network device 110 may include, for example, a New Radio (NR) base station, a Long-Term Evolution (LTE) base station, a Node B, an eNB, a gNodeB, an access point, a transmission reception point (TRP), a DU, an RU, a CU, a mobility element of a network, a core network node, a network element, a network equipment, and/or a RAN node. The network device 110 may be a packet data network gateway (PGW), a home subscriber server (HSS), or another type of network element.

The network 502 may include one or more wired and/or wireless networks. The network 502 may include a terrestrial network. For example, the network 502 may include a cellular network (e.g., a Fifth Generation (5G) network, a Fourth Generation (4G) network, an LTE network, a Third Generation network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 502 enables communication among the devices of environment 500.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

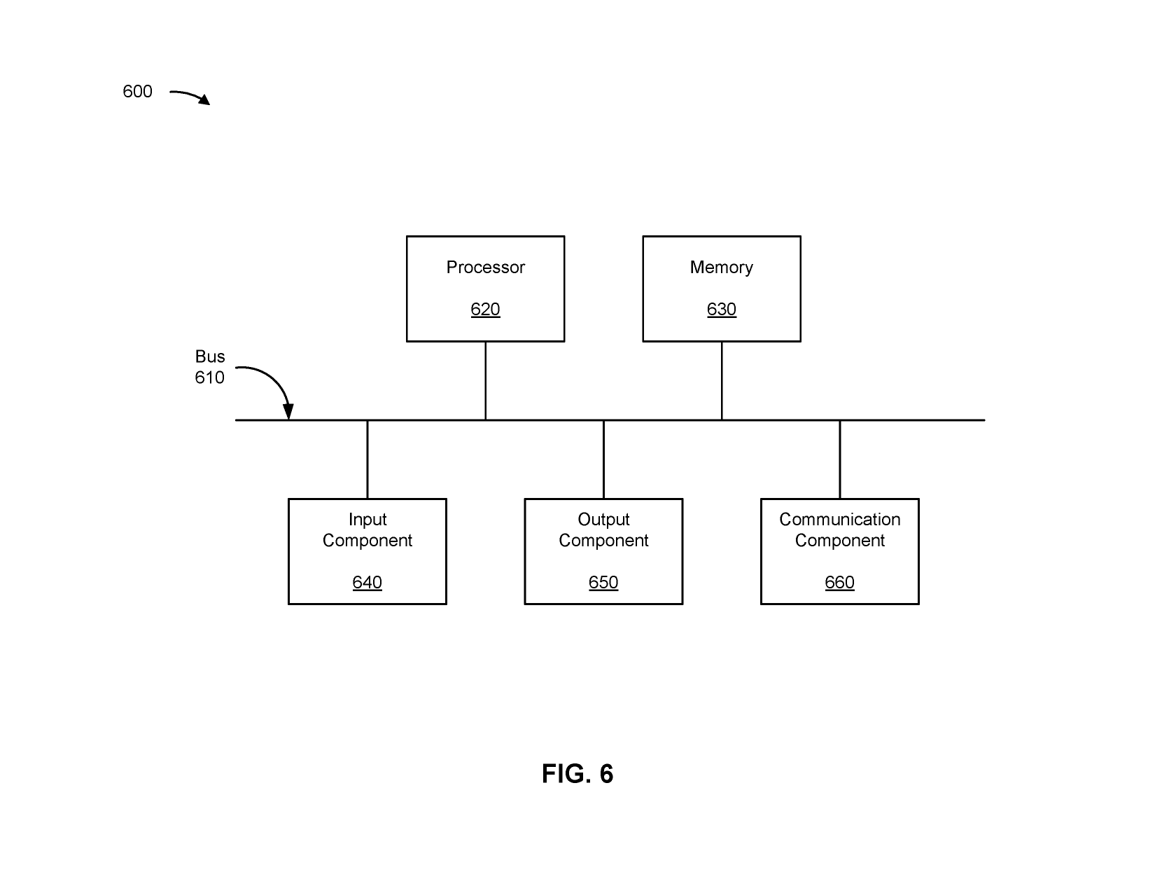

FIG. 6 is a diagram of example components of a device 600 associated with locking and unlocking SIMs. The device 600 may correspond to a device, such as a SIM (e.g., SIM 104) or a UE (e.g., UE 106). In some implementations, the device may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. In some implementations, the processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. In some implementations, the memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. In some implementations, execution of the set of instructions, by one or more processors 620, causes the one or more processors 620 and/or the device 600 to perform one or more operations or processes described herein. In some implementations, hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

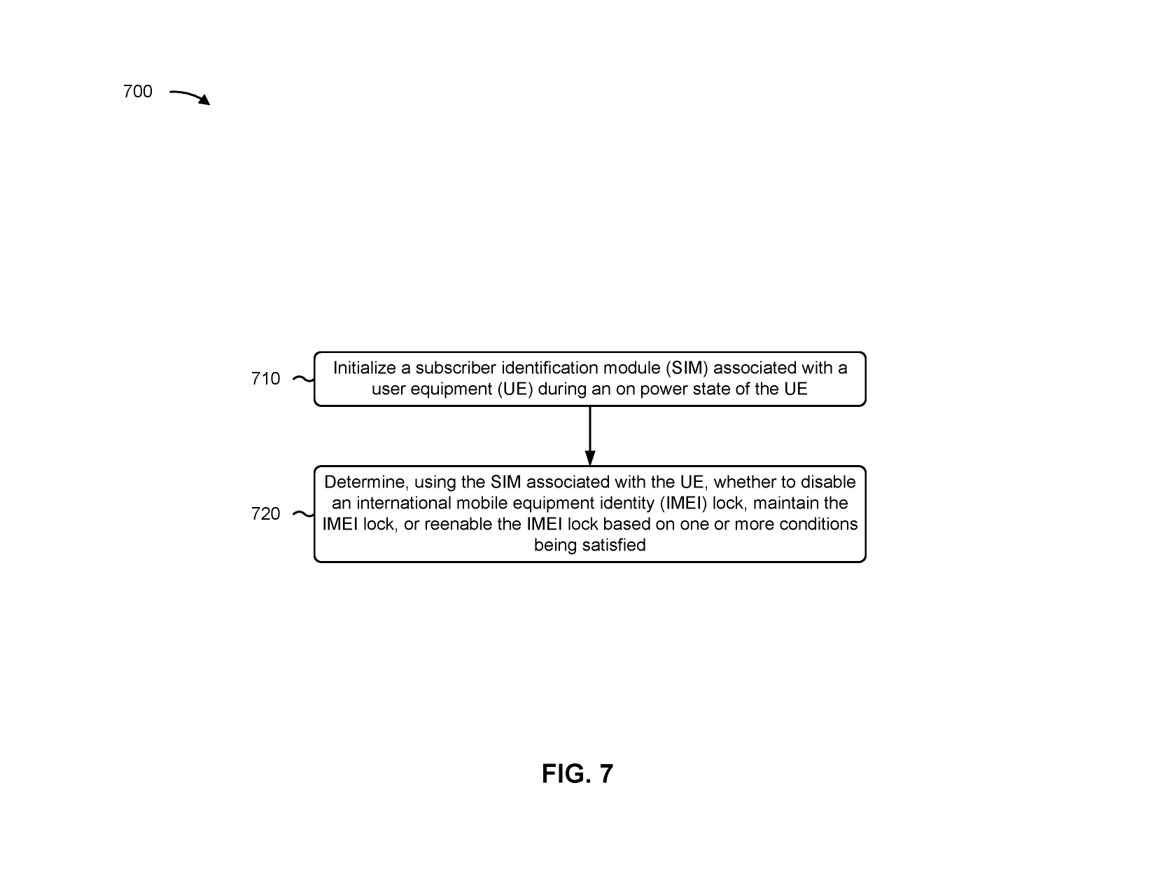

FIG. 7 is a flowchart of an example process 700 associated with locking and unlocking SIMs. In some implementations, one or more process blocks of FIG. 7 may be performed by a device, such as a SIM (e.g., SIM 104) or a UE (e.g., UE 106). In some implementations, one or more process blocks of FIG. 7 may be performed by another device or a group of devices separate from or including the device. Additionally, or alternatively, one or more process blocks of FIG. 7 may be performed by one or more components of device 600, such as processor 620, memory 630, input component 640, output component 650, and/or communication component 660.

As shown in FIG. 7, process 700 may include initializing a SIM associated with the UE during an on power state of the UE (block 710). The SIM may be locked to the UE based on an IMEI lock being enabled. The UE may be powered on with the SIM inserted in the UE. The SIM may be a prepaid SIM. The SIM may be manufactured with an IMEI lock enabled.

As shown in FIG. 7, process 700 may include determining, using the SIM associated with the UE, whether to disable the IMEI lock, maintain the IMEI lock, or reenable the IMEI lock based on one or more conditions being satisfied (block 720). The SIM may not be locked to the UE when the IMEI lock is disabled. The one or more conditions may be satisfied based on a BIP check, an IMEI application counter, and/or profile information. The IMEI lock may be enabled or disabled to prevent the SIM from being used to launch spam or scam related communications.

In some implementations, the UE may be a first UE. The SIM and/or the first UE may perform a BIP check to determine whether the SIM is able to communicate with a SIM OTA platform. The SIM and/or the first UE may disable the IMEI lock based on the BIP check. The SIM and/or the first UE may start an IMEI application counter based on a flag generated for the first UE. The SIM may increment the IMEI application counter when the SIM is moved to a second UE. The SIM may detect that the IMEI application counter has reached a defined threshold. The SIM and/or the second UE may enable the IMEI lock, wherein the SIM is locked to the second UE based on the IMEI lock being enabled. The SIM and/or the second UE may disable the IMEI lock to the second UE based on user information.

In some implementations, the SIM and/or the UE may perform a BIP check to determine whether the SIM is able to communicate with a SIM OTA platform. The SIM and/or the UE may maintain the IMEI lock based on the BIP check.

In some implementations, the UE may be a first UE. The SIM and/or the first UE may perform a first BIP check to determine whether the SIM is able to communicate with a SIM OTA platform. The SIM and/or the first UE may disable the IMEI lock based on the first BIP check. The SIM may initialize during an on power state of a second UE based on the SIM being moved to the second UE. The SIM and/or the second UE may disable the IMEI lock. The SIM and/or the second UE may perform a second BIP check to determine whether the SIM is able to communicate with the SIM OTA platform. The SIM and/or the second UE may enable the IMEI lock based on the second BIP check, wherein the SIM is locked to the second UE based on the IMEI lock being enabled.

In some implementations, the SIM and/or the UE may perform a first BIP check to determine whether the SIM is able to communicate with a SIM OTA platform. The SIM and/or the UE may disable the IMEI lock based on the first BIP check. The SIM may initialize during the on power state of the UE. The SIM and/or the UE may disable the IMEI lock. The SIM and/or the UE may perform a second BIP check to determine whether the SIM is able to communicate with the SIM OTA platform. The SIM and/or the UE may receive a BIP failure message based on the second BIP check. The SIM and/or the UE may enable the IMEI lock based on the second BIP check.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
initializing a subscriber identification module (SIM) associated with a user equipment (UE) during an on power state of the UE, wherein the SIM is locked to the UE based on an international mobile equipment identity (IMEI) lock being enabled; and
determining, using the SIM associated with the UE, whether to disable the IMEI lock, maintain the IMEI lock, or reenable the IMEI lock based on one or more conditions being satisfied, wherein the SIM is not locked to the UE when the IMEI lock is disabled.

2. The method of claim 1, wherein the UE is a first UE, and further comprising:
performing, using the SIM, a bearer independent protocol (BIP) check to determine whether the SIM is able to communicate with a SIM over-the-air (OTA) platform;
disabling, using the SIM, the IMEI lock based on the BIP check;
starting, using the SIM, an IMEI application counter based on a flag generated for the first UE;
incrementing, using the SIM, the IMEI application counter when the SIM is moved to a second UE;
detecting, using the SIM, that the IMEI application counter has reached a defined threshold; and
enabling, using the SIM, the IMEI lock, wherein the SIM is locked to the second UE based on the IMEI lock being enabled.

3. The method of claim 2, further comprising:
disabling, using the SIM, the IMEI lock to the second UE based on user information.

4. The method of claim 1, further comprising:
performing, using the SIM, a bearer independent protocol (BIP) check to determine whether the SIM is able to communicate with a SIM over-the-air (OTA) platform; and
maintaining, using the SIM, the IMEI lock based on the BIP check.

5. The method of claim 1, wherein the UE is a first UE, and further comprising:
performing, using the SIM, a first bearer independent protocol (BIP) check to determine whether the SIM is able to communicate with a SIM over-the-air (OTA) platform;
disabling, using the SIM, the IMEI lock based on the first BIP check;
initializing the SIM during an on power state of a second UE based on the SIM being moved to the second UE;
disabling, using the SIM, the IMEI lock;
performing, using the SIM, a second BIP check to determine whether the SIM is able to communicate with the SIM OTA platform; and
enabling, using the SIM, the IMEI lock based on the second BIP check, wherein the SIM is locked to the second UE based on the IMEI lock being enabled.

6. The method of claim 1, further comprising:
performing, using the SIM, a first bearer independent protocol (BIP) check to determine whether the SIM is able to communicate with a SIM over-the-air (OTA) platform;
disabling, using the SIM, the IMEI lock based on the first BIP check;
initialize the SIM during the on power state of the UE;
disabling, using the SIM, the IMEI lock;
performing, using the SIM, a second BIP check to determine whether the SIM is able to communicate with the SIM OTA platform;
receiving, by the SIM, a BIP failure message based on the second BIP check; and
enabling, using the SIM, the IMEI lock based on the second BIP check.

7. The method of claim 1, wherein the one or more conditions are satisfied based on one or more of: a bearer independent protocol (BIP) check, an IMEI application counter, or profile information.

8. The method of claim 1, wherein the SIM is a prepaid SIM.

9. The method of claim 1, wherein the SIM is manufactured with the IMEI lock enabled.

10. The method of claim 1, wherein the IMEI lock is enabled or disabled to prevent the SIM from being used to launch spam or scam related communications.

11. A subscriber identification module (SIM) associated with a user equipment (UE), the SIM comprising:
one or more components configured to:
initialize the SIM during an on power state of the UE, wherein the SIM is locked to the UE based on an international mobile equipment identity (IMEI) lock being enabled; and
determine whether to disable the IMEI lock, maintain the IMEI lock, or reenable the IMEI lock based on one or more conditions being satisfied, wherein the SIM is not locked to the UE when the IMEI lock is disabled.

12. The SIM of claim 11, wherein the UE is a first UE, and wherein the one or more components are further configured to:
perform a bearer independent protocol (BIP) check to determine whether the SIM is able to communicate with a SIM over-the-air (OTA) platform;
disable the IMEI lock based on the BIP check;
start an IMEI application counter based on a flag generated for the first UE;
increment the IMEI application counter when the SIM is moved to a second UE;
detect that the IMEI application counter has reached a defined threshold; and
enable the IMEI lock, wherein the SIM is locked to the second UE based on the IMEI lock being enabled.

13. The SIM of claim 11, wherein the one or more components are further configured to:
perform a bearer independent protocol (BIP) check to determine whether the SIM is able to communicate with a SIM over-the-air (OTA) platform; and
maintain the IMEI lock based on the BIP check.

14. The SIM of claim 11, wherein the UE is a first UE, and wherein the one or more components are further configured to:
perform a first bearer independent protocol (BIP) check to determine whether the SIM is able to communicate with a SIM over-the-air (OTA) platform;
disable the IMEI lock based on the first BIP check;
initiate the SIM during an on power state of a second UE based on the SIM being moved to the second UE;
disable the IMEI lock;
perform a second BIP check to determine whether the SIM is able to communicate with the SIM OTA platform; and
enable the IMEI lock based on the second BIP check, wherein the SIM is locked to the second UE based on the IMEI lock being enabled.

15. The SIM of claim 11, wherein the one or more components are further configured to:
perform a first bearer independent protocol (BIP) check to determine whether the SIM is able to communicate with a SIM over-the-air (OTA) platform;
disable the IMEI lock based on the first BIP check;
initialize the SIM during the on power state of the UE;
disable the IMEI lock;
perform a second BIP check to determine whether the SIM is able to communicate with the SIM OTA platform;
receive a BIP failure message based on the second BIP check; and
enable the IMEI lock based on the second BIP check.

16. The SIM of claim 11, wherein the one or more conditions are satisfied based on one or more of: a bearer independent protocol (BIP) check, an IMEI application counter, or profile information.

17. The SIM of claim 11, wherein the SIM is a prepaid SIM.

18. The SIM of claim 11, wherein the SIM is manufactured with the IMEI lock enabled.

19. The SIM of claim 11, wherein the IMEI lock is enabled or disabled to prevent the SIM from being used to launch spam or scam related communications.

20. A non-transitory computer-readable medium storing a set of instructions, the set of instructions comprising:
one or more instructions that, when executed by one or more components of a subscriber identification module (SIM) associated with a user equipment (UE), cause the SIM to:
initialize the SIM during an on power state of the UE, wherein the SIM is locked to the UE based on an international mobile equipment identity (IMEI) lock being enabled; and
determine whether to disable the IMEI lock, maintain the IMEI lock, or reenable the IMEI lock based on one or more conditions being satisfied, wherein the SIM is not locked to the UE when the IMEI lock is disabled.
